(19) United States
(12) Patent Application Publication
(10) Pub. No.: US 2007/0263779 A1
(43) Pub. Date: Nov. 15, 2007

(54) Device and method for simulating a telephonic condition

(76) Inventor: James Bradley, Carp (CA)

Correspondence Address: THE LAW OFFICES OF THOMAS L. ADAMS, 120 EAGLE ROCK AVENUE, P.O. BOX 340, EAST HANOVER, NJ, 07936, US

(21) Appl. No.: 11/405,709

(22) Filed: Apr. 18, 2006

(51) Int. Cl. H04M 1/24; H04M 3/08; H04M 3/22

(52) U.S. Cl. 379/29.02

(57) ABSTRACT

A device for simulating a telephonic condition has a generator for producing a simulation signal that can simulate an audible signal produced on a telephone for signifying a second incoming call. The generator has an output adapted to send the simulation signal over a telephone line. A manual control is coupled to the generator for operating it.

### BACKGROUND OF THE INVENTION

1. Field of the Invention

The present invention relates to devices for simulating conditions on the telephone system and, in particular, to devices allowing one party to simulate a condition that is perceived by another party.

2. Description of Related Art

The ubiquitous telephone can be both convenient and intrusive. Ending an unwanted telephone call without giving offense can be difficult. At times a party to the telephone conversation may be relieved to hear a call waiting signal that gives the party an opportunity to announce that the current conversation must end, because the incoming call can then be described as important, urgent, etc. In some circumstances the called party may know from caller ID or from telltale audible artifacts that the incoming call is from a telemarketer or some other unwelcome caller. In all of these circumstances a party may wish to terminate or preclude a conversation but lack a convenient or polite way to do so.

In U.S. Pat. No. 6,130,936 after answering the telephone the called party can press a button to produce a noise signal suggesting a problem with the telephone line, so that the called party can hang up without further comment.

In U.S. Pat. No. 5,029,198 a user can select a synthesized message to play to a calling party. For example the user can select the message “I'm sorry, but you have dialed the wrong number-please dial more carefully.”

In U.S. Pat. No. 5,189,692 a call recipient can press certain buttons on a keypad to synthesize spoken questions, announcements, and background noise.

The call recipient can also generate a ring back sound to simulate a call transfer.

In U.S. Pat. No. 6,125,175 a caller first connects to a network node to request a background sound such as the sounds of a restaurant, forest, beach, city traffic, etc. Then when a call is later made, the called party hears the requested background sounds, which have been inserted by the network node.

In U.S. Pat. No. 5,553,125 the caller ID of an incoming call is checked against a registry. If this caller has been flagged, the system will produce a false busy signal to discourage this caller.

In U.S. Pat. No. 4,429,188 an automatic call screener answers a telephone and generates a false calling tone simulating an unanswered telephone. The system waits for the caller to issue certain DMTF tones with proper timing, otherwise the call is terminated.

In U.S. Pat. No. 6,671,369 all calls are answered by initially producing one of seven versions of the SIT in order to defeat telemarketing calls. See also U.S. Patent Application Publication No. 2002/0041666.

In U.S. Pat. No. 6,775,364 after examining a caller ID, the system can produce a false SIT to frustrate the caller. See also U.S. Pat. Nos. 6,707,895 and 6,807,260.

In U.S. Pat. No. 5,764,742 a portable device in the form of a calling card or key fob can a generate DMTF tones to automatically dial a party. See also U.S. Pat. Nos. 5,539,819 and 6,678,373.

In U.S. Pat. No. 6,481,623 a credit card can be swiped in a portable device having a modulator that generates on a speaker an audible signal that can be transmitted by telephone to, for example, a merchant that needs credit card information.

In U.S. Pat. No. 6,121,877 a device placed in a knapsack can produce a distinctive sound when the knapsack is opened. The sound can be music, the beeping sound of a pager or telephone, a siren sound, etc.

In U.S. Pat. No. 5,005,002 a hand-held siren is activated by a panic button. See also U.S. Pat. No. 5,748,089.

The hand-held translator of U.S. Pat. No. 4,631,748 can synthesize speech.

The portable device in U.S. Pat. No. 5,197,332 can produce sounds for testing a patient's hearing. See also U.S. Pat. No. 6,350,243.

### SUMMARY OF THE INVENTION

In accordance with the illustrative embodiments demonstrating features and advantages of the present invention, there is provided a device for simulating a telephonic condition. The device has a generator for producing a simulation signal that can simulate an audible signal produced on a telephone for signifying a second incoming call. The generator has an output adapted to send the simulation signal over a telephone line. A manual control is coupled to the generator for operating it.

In accordance with another aspect of the invention, a method is provided for simulating a telephonic condition. The method includes the step of generating a simulation signal simulating an audible signal produced on a telephone for signifying a second incoming call. Another step is manually operating the generator. The method also includes the step of sending the simulation signal over a telephone line.

By employing devices and methods of the foregoing type, a party can effectively preclude or terminate an unwanted telephone conversation. In one embodiment a microprocessor can store in digital memory data signifying the audible sound produced by call waiting. In another embodiment a singular, or plurality of timers or state circuitry simulate the desired signal. In these cases the simulation is being conducted for the sake of the other party, i.e., to create an excuse to terminate an ongoing telephone conversation. Accordingly, the microprocessor can either send a specific sound over the telephone line or may blank the line, that is, create an interval of silence that the other party will interpret as the interruption caused by call waiting.

In some embodiments the device uses at least one of: an indication of the calling entity's identity via calling line identification, or an another indication of the party indicating the intent of communication.

In some embodiments the device will be a handheld casing containing a generator and speaker. The speaker may be placed against the microphone of the telephone handset to acoustically couple the simulation signal for the sake of the other party.

In some embodiments the device directly couples to either the telephone line or the line between the handset and the telephone base

In some embodiments the device and method envisage being powered from the line it is attached to.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a schematic block diagram of a device in accordance with principles of the present invention;

FIG. 2 is a flowchart associated with the generator of FIG. 1;

FIG. 3 is a casing containing the generator FIG. 1;

FIG. 4 is a credit card-sized casing containing the generator of FIG. 1;

FIG. 5 is perspective view of a printed circuit card embodying the generator of FIG. 1 and designed to plug into a personal computer;

FIG. 6 is a casing containing the generator FIG. 1 and designed to electrically connect to a telephone line by serial connection into the line of the handset;

FIG. 7 shows the device of FIG. 6 connecting between the telephone handset and telephone base;

FIG. 8 is a casing with an eyelet, this casing being an alternate to that of FIG. 3;

FIG. 9 is a casing containing the generator FIG. 1 and designed to electrically connect to a telephone line;

FIG. 10 is a schematic diagram showing the generator of FIG. 1 on a circuit card in a personal computer;

FIG. 11 is a schematic block diagram of the generator of FIG. 1 built into a stand-alone telephone;

FIG. 12 shows the casing for the circuit of FIG. 11;

FIG. 13 is a flowchart showing software adapted to implement the generator of FIG. 1 by means of a voice over network connection;

FIG. 14 shows a printed circuit card designed to plug into a personal computer and implement the software of FIG. 13;

FIG. 15 shows the network connection associated with the software and hardware of FIGS. 13 and 14;

FIG. 16 shows a network connection that is an alternate to that of FIG. 15; and

FIG. 17 is a timing diagram associated with the generator FIG. 1

### DETAILED DESCRIPTION OF THE PREFERRED EMBODIMENTS

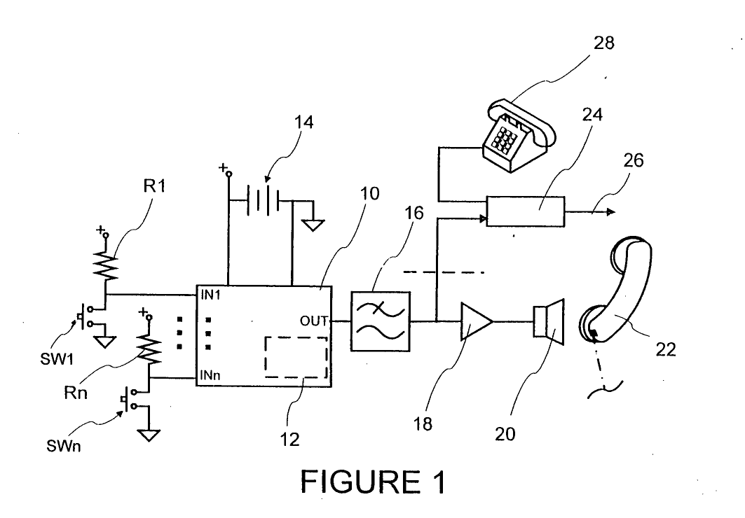

Referring to the schematic diagram of FIG. 1, a device for simulating a telephonic condition employs a generator 10 in the form of a microcomputer 10 with memory 12. Microcomputer 10 is powered by battery 14 whose negative terminal is connected to ground. Microcomputer 10 has a manual control in the form of a number of pushbutton inputs IN1 through INn connected to (a) pull-up resistors R1 through Rn, respectively, and (b) one terminal of the pushbutton switches SW1 through SWn, respectively, whose other terminals are grounded. The number of pushbutton switches can vary from embodiment to embodiment and in some cases only one or two switches may be used. The pushbutton switches are referred to as a manually operable interface. Additionally the pull-up resistors in the switch arrangements may be replaced with pull-down resistors or similar arrangements.

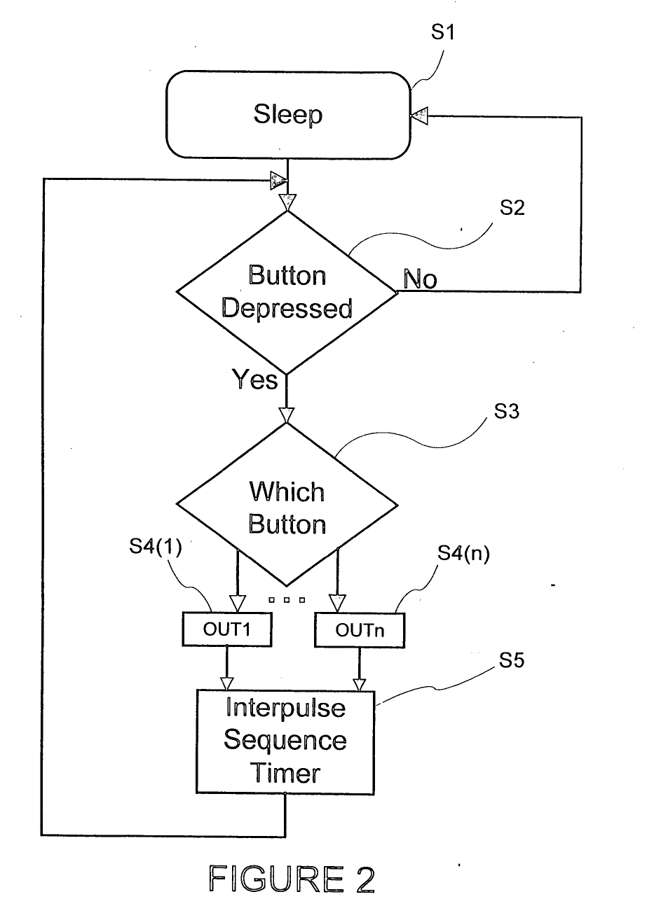

Referring to FIGS. 1 and 2, the illustrated flowchart depicts the program running in the microcomputer 10 of FIG. 1. When quiescent, the program remains in step SI waiting for depression of one of the pushbuttons (switches SW1 through SWn of FIG. 1). When one of these buttons is pressed the microcomputer awakens and begins executing a routine to determine which of these buttons was depressed. A single depression of one of the pushbuttons (switches SW1 through SWn of FIG. 1) at step S2 will cause the microcomputer to determine which of the switches was depressed (Step S3). Upon determination of which of the pushbuttons was depressed the appropriate output routine will execute the appropriate sequence of pulse density modulation (S(1) to S(n)) to be output to the appropriate output pin (pin OUT of microcomputer 10 of FIG. 1). For example, if the first button (pushbutton switch SW1 of FIG. 1) is depressed, an output will be produced in step S4(1).

At the completion of the sequence, the microcomputer samples the pushbutton inputs before going back to sleep. If one of the pushbuttons remains depressed the microcomputer will wait (step S5) the appropriate time period before repeating the pulse sequence (representing a fixed value of typically 4 to 6 seconds), at which time the microcomputer will execute the routine causing the pulse sequence to be output again and so on until the push button is released and the microcomputer goes back to sleep (step S1).

In one embodiment memory 12 (of FIG. 1) returns values representing a waveform representing one specific audible signal. In some cases the waveform will be produced through a digital to analog converter (either internal to microcomputer 10 or external thereto). In other embodiments the data stored in memory 12 of FIG. 1 may represent a plurality of bit sequences each having a specific duty cycle. These bit sequences may be in the form of pulse code modulation or pulse density modulation. Accordingly, the succession of bit sequences that are played back from memory 12 of FIG. 1 can be averaged to produce a waveform representing a specific audible signal.

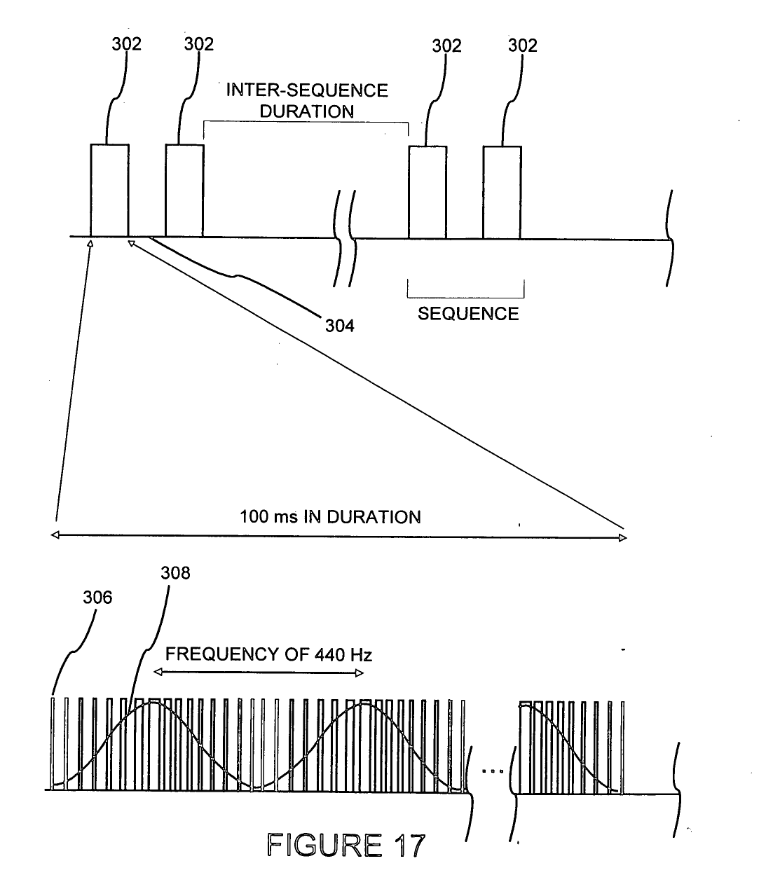

Referring to FIG. 17 an output signal is shown as pairs of tones 302 (100 milliseconds long and separated 100 milliseconds); although the tones can be reduced as singletons, trios. etc. The pairs 302 repeat after an inter-sequence duration of about 4-6 seconds. Each tone 302 is generated by width modulated pulses 306. Basically, the duty cycle is modulated so that the average value of the pulse train will vary to form, after filtering, waveform 308. In this case waveform 308 is a sine wave of 440 Hz. It will be appreciated that other waveforms having more complicated shapes and spectrums can be generated in this fashion, and also that the duration and spacing of tone intervals 302 can be varied as needed.

Referring again to FIG. 1, in some from embodiments memory 12 can store a sequence of codes corresponding to a succession of phonemes representing speech or tones. By processing these encoded phonemes and tones through a speech or tone synthesizer, the system can produce a synthesized message. Still another embodiment is contemplated where the device has a number of separate tone generators that are operated sequentially to provide a simulation signal. Still another embodiment is contemplated where the device has a plurality of timers that can be used to provide at least an indication of a simulation signal.

The output OUT of microcomputer 10 will typically be quantized and for that reason this output will be passed through a low pass filter 16 to remove high frequency components and smooth the waveform generated by microcomputer 10 of FIG. 1. This filtered output will then be amplified by amplifier 18, which drives a transducer, for example, speaker 20. In yet another envisaged embodiment the transducer is a piezoelectric acoustic device. Speaker 20 of FIG. 1 is shown adjacent to telephone handset 22 to acoustically couple speaker 20 to the telephone's microphone.

In some embodiments the signal produced by microcomputer 10 can be pre-distorted to compensate for the transfer function of the output chain, such that the signal sounds just as it should, even though the output chain has some non-linearity or other distorting transfer function.

A coupler 24 is shown in FIG. 1 as an optional accessory connected to the output of low pass filter 16. Coupler 24 is shown connected to a telephone line (or other telephonic link), but in other embodiments may be connected in the handset line, as discussed further hereinafter. With the illustrated embodiment, coupler 24 simply connects telephone 28 to telephone line 26 under normal circumstances.

When, however, an output is produced from filter 16 that signal can be coupled to telephone line 26.

The coupler 24 can be an audio mixer for mixing the output of filter 16 with the output of telephone 28. In some embodiments coupler 24 may have an active switch to disconnect telephone 28 and substitute therefor the output of filter 16. An active switch can be especially useful when the goal is to produce a silent or quiet line (intervening quiet interval), in which case the output from filter 16 may simply be a control signal for controlling the active switch in coupler 24. In other instances the active switch may be arranged to transfer an audible signal from filter 16, in which case a threshold detector (not shown) in coupler 24 will detect the incoming signal and operate the active switch.

When the simulation signal stored in memory 12 is finished the program of microcomputer 10 executes step S5 to set a timer, which then remains in the set state for a predetermined interval of time. After setting the timer the program returns to step S2 determining if the button (one of SW1 to SWn) remains depressed, failing which it will return to step S1. If the microcomputer passes the test at step S2 it will repeat the output sequence at step S4, and continue in this sequence. In, for example, step S4(n) microcomputer 10 will fetch from memory 12 an alternate simulation signal that will be played back through transducer 20.

In yet another embodiment the inter pulse-sequence timer S5 is set to a very small value and the sequence is set corresponding to a relatively long sequence representing the response of a facsimile machine having been dialed.

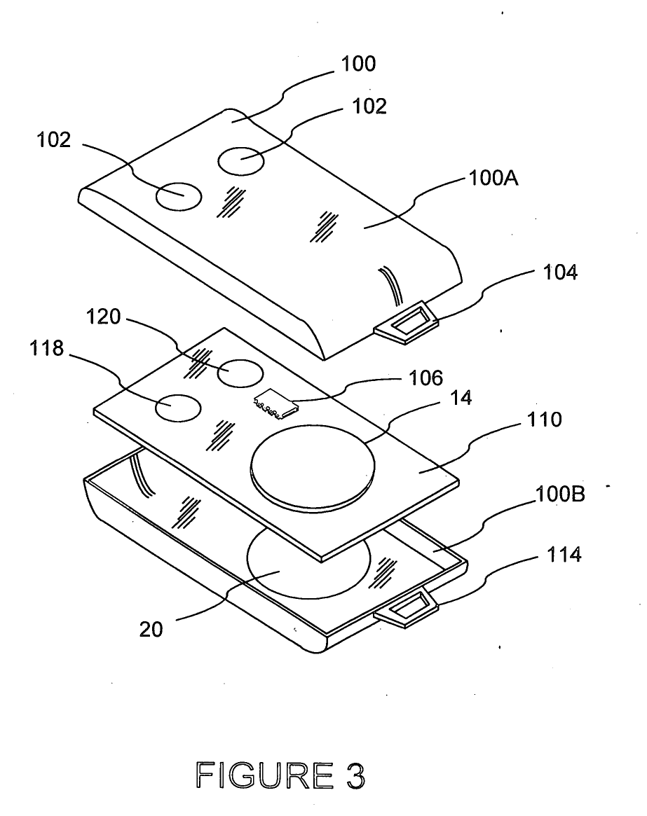

Referring to FIG. 3, the device of FIG. 1 (excluding coupler 24) is packaged in a clamshell casing 100, comprising shell halves 100A and 100B. Halves 100A and 100B have rings 104 and 114, respectively, allowing the user to attach case 100 to a key chain or other implement.

Mounted inside casing 100 is a printed circuit board 110 having previously mentioned transducer 20 and two pushbutton switches 118 and 120 (corresponding to previously mentioned switches SW1 and SWn). Pushbutton switches 118 and 120 are operable through pads 102 in casing half 100A. Pads 102 are openings fitted with a flexible membrane that allows a user to apply finger pressure to the pushbutton switches.

Integrated circuit 106 contains the previously mentioned microprocessor and is accompanied on the printed circuit board by the pull-up resistors of FIG. 1. A battery 14 is mounted on the top side of the printed circuit board 110.

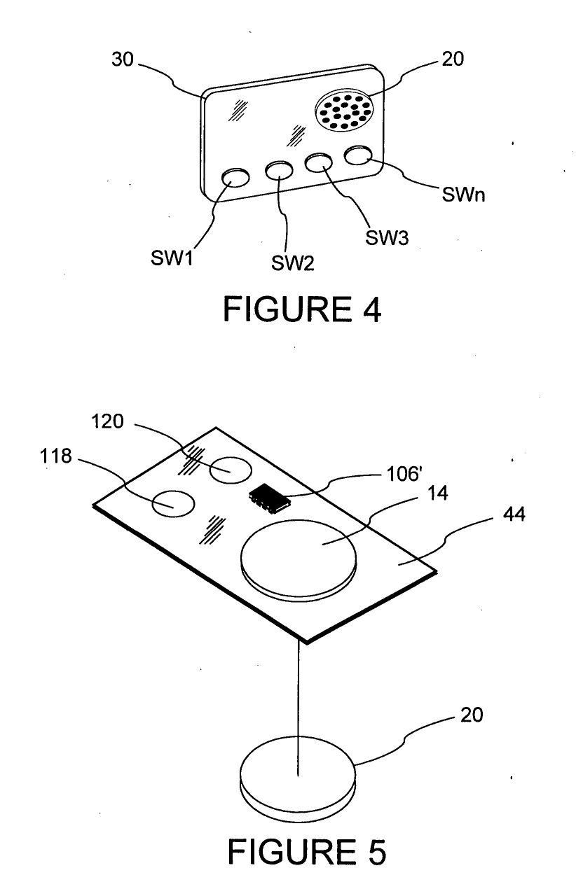

Referring to FIG. 4, the device of FIG. 1 (excluding coupler 24) is packaged in a credit card format casing 30. Casing 30 is handheld and wallet-sized, i.e. easily placed in a wallet. Casing 30 also contains the hardware and software for driving the speaker 20, which hardware and software was previously illustrated in FIGS. 1 and 2. Casing 30 also has the previously mentioned switches SW1 through SWn, as well as two additional, explicitly illustrated switches SW2 and SW3 to provide a complement of four switches. It will be understood that this embodiment does not have the previously mentioned coupler (coupler 24 of FIG. 1), although in some embodiments an external coupler can be connected to a connector (not shown) on casing 30.

Referring to FIG. 5, the device of FIG. 1 (including coupler 24) is packaged in a computer card format. The unit can be powered by battery 14 and use switches 118 and 120, as well as, audio transducer 20 as illustrated. It is envisaged that this exemplary embodiment will arrange these switches 118 and 120 to be either controlled via software, externally via hardware or a combination of both. It will also be appreciated that this card 44 may be powered by power available at the computer bus interface. As before integrated circuit 106′ and in (similar to the integrated circuit 106 of FIG. 3 but modified to accomplish the old features described above) contains the previously mentioned microprocessor and is accompanied on the printed circuit board by the pull-up resistors of FIG. 1.

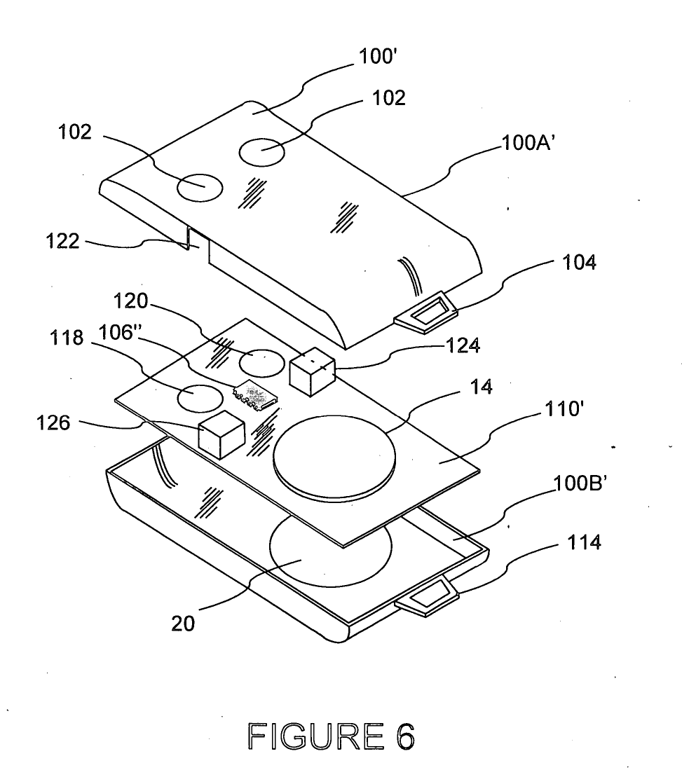

Referring to FIG. 6, components corresponding to those previously illustrated in FIG. 3 will have the same reference numeral if identical, but will be marked with a prime (′) if modified somewhat. The device of FIG. 1 is packaged in a stand-alone configuration. This device now has a coupler similar to coupler 24 of FIG. 1, but adapted to permit connection into the telephone line (or other telephonic link) by being connected between a telephone handset and a telephone base.

The individual elements were already described in FIG. 3 with the exception of modular jacks 124 and 126, used for connecting into the telephone connection between the handset and base. Lug halves 104 and 114 although shown are optional in this configuration. Integrated circuit 106″ (similar to the integrated circuit 106 of FIG. 3 but modified to accomplish all the features described above) contains the previously mentioned microprocessor and is accompanied on printed circuit board 110′ by the pull-up resistors of FIG. 1.

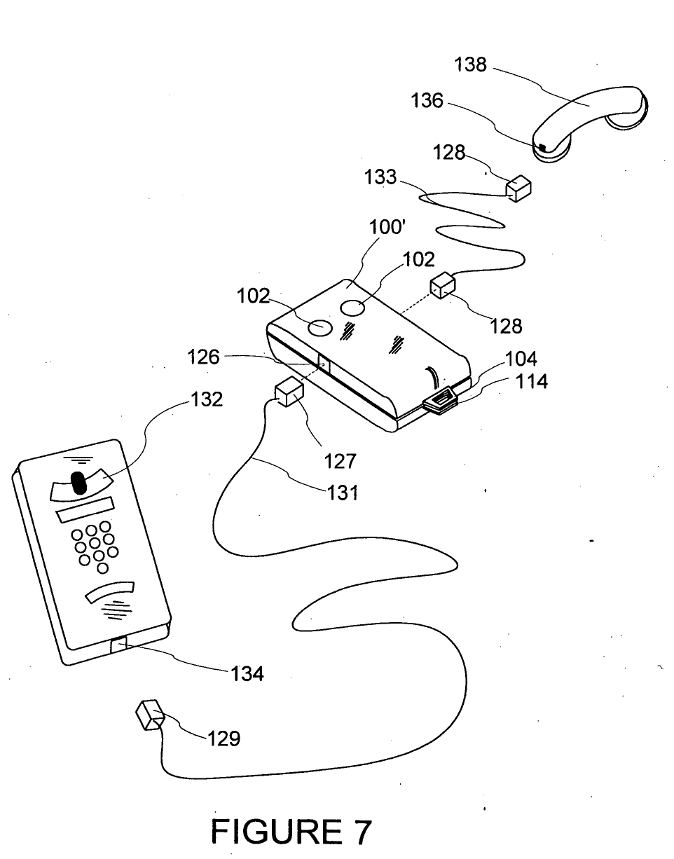

Referring to FIG. 7, the casing of FIG. 6 is shown assembled and arranged so that modular jack 126 can connect to plug 127, which in turn connects through line 131 to modular plug 129, shown plugging into the modular jack 134 of telephone base 132. The other modular jack tack 124 of FIG. 6) is shown connecting to telephone handset 138 by means of the modular plugs 128 on line 133.

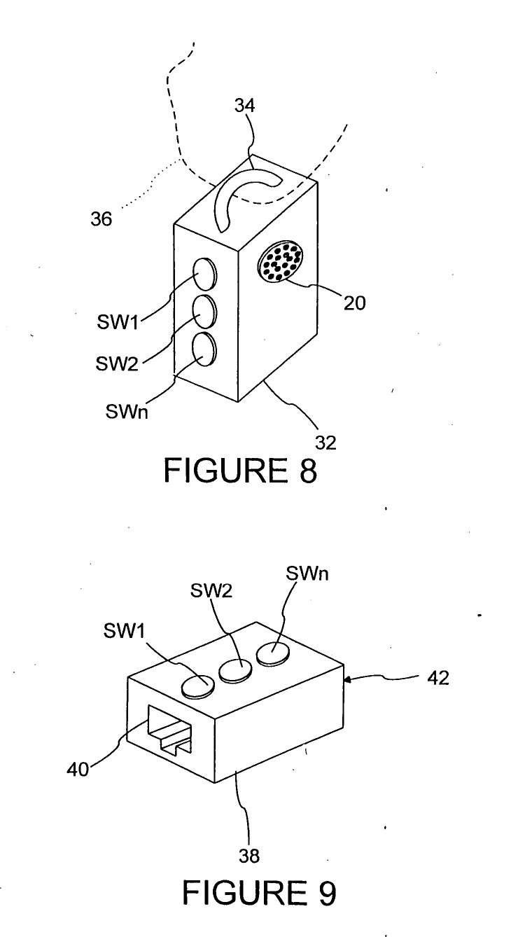

Referring to FIG. 8, alternate casing 32 is designed as a key fob with an eyelet 34 for encircling a key ring or key chain 36. The eyelet 34 can also be used for attaching casing 32 to a necklace, bracelet, lanyard, or any other similar object so the casing is not easily lost or misplaced. In some embodiments, casing 32 may have an adhesive backer (not shown) for attaching the casing to a telephone or a surface near a telephone. While casing 32 is shown as a rectangular object, other shapes are contemplated, such as shapes that are polyhedral, spherical, ovoid, annular, miniature replicas of some other object, etc.

Previously mentioned speaker 20 is shown mounted on the front of casing 32, while three pushbuttons SW1-SWn are shown mounted on the left side of the casing. It will be appreciated that additional pushbuttons can be mounted on the other faces of casing 32.

Referring to FIG. 9, casing 38 contains the hardware and software for driving speaker 20 that was previously illustrated in FIGS. 1 and 2. Casing 38 does not have the transducer itself, but has instead the previously mentioned coupler (coupler 24 of FIG. 1). In fact, the telephone line can be connected to this coupler through a connector assembly employing two modular connectors: one connector 40 located on one end of casing 38 and the other connector located on the opposite end 42, but not visible in this Figure. Accordingly, a telephone will be serially connected to a telephone line through casing 38. Casing 38 also has the previously mentioned pushbutton switches SW1 through SWn, one additional switch SW2 being explicitly illustrated to provide a complement of three switches.

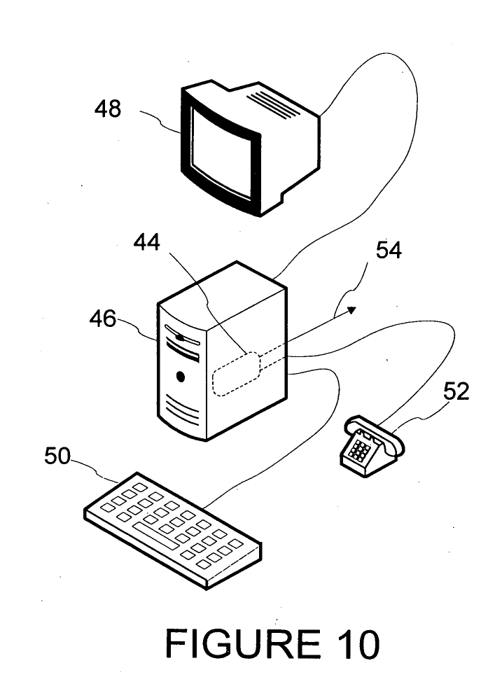

Referring to FIG. 10, the electronic circuits of the device of FIG. 5 are mounted on a circuit card 44 that is plugged into a slot of a conventional personal computer 46, shown employing a monitor 48 and a keyboard 50. Card 44 has a connector assembly (as described before in FIG. 5) for connecting to telephone 52 and telephone line 54. Card 44 does not have the previously mentioned pushbuttons, but instead has software controlled switches. Therefore, keyboard 50 operates as the manual control (with the keys a manually operable interface) to effectively close transistor switches (not shown) on card 44 to operate the device in the manner previously mentioned.

It will be appreciated that a larger fraction of the operations described herein can be done with more of the functionality performed in software so that software interfaces replace the hardware interfaces and functions previously mentioned.

It will be appreciated that even the output of this device may be a software interface.

To facilitate an understanding of the principles associated with the foregoing apparatus, its operation will be briefly described in connection with the apparatus of FIGS. 1, 2, and 3. It will be appreciated that the devices of FIGS. 4 and 8 operate in substantially the same manner.

A user may keep the illustrated device of FIG. 3 near a telephone or carry the device in a wallet, purse, pocket, briefcase, etc. When the user has started a telephone conversation and now wishes to end it, the speaker 20 of device 30 can be placed next to the microphone of the telephone handset 22 (FIG. 1). If the user presses button SW1 microcomputer 10, in the manner previously described, produces on speaker 20 an audible signal based on the simulation signal stored in memory 12. Alternatively the output can be a signal produced by appropriately configured timers. This audible signal sounds like what is heard by a remote party when the local party receives a call waiting signal. In some instances the signal will be a specific pair of tones.

If the user should immediately press button SW1 again, no audible signal will be produced until the Inter Pulse Sequence Timer (step S5 of FIG. 2) times out. This avoids a situation where the simulation is defeated by rapid repetition of the signal in a way that is unlike an actual call waiting signal. This feature even handles the case where the user continuously presses button SW1. In such a case the simulated call waiting signal will repeat, for example, every four to five seconds.

In some cases a user may press a different button, for example, button SWn. In such a case microcomputer 10 will produce on speaker 20 an alternate audible simulation signal, for example, the distinctive sound made when a facsimile machine answers a telephone line. This simulation may be very useful when the called party is fairly certain that the caller is a telemarketer or other disfavored caller. Then, the user can lift the telephone receiver off hook and place speaker 20 against the handset's microphone before pressing button SWn. In a manner similar to that previously described, microcomputer 10 produces an audible signal on speaker 20 simulating the distinctive facsimile sound. This technique is especially effective with telemarketers who will then deem the called number unusable and typically remove the number from their calling list.

A variety of alternate signals for simulating a variety of telephonic conditions can be produced by pressing a different button or a combination of buttons SW1 through SWn. For example, microcomputer 10 can simulate a vacant-line sound, reorder tones, an out of zone sound, or any of the known SIT (system information tones). Also, microcomputer 10 can synthesize speech, for example: “the number you have dialed is no longer in service;” “operator 916;” etc. Also, in some embodiments microcomputer 10 can simulate the alarm that sounds when a battery is nearly drained in a cellphone, or some other telephonic device or apparatus (e.g., a smart phone, PDA with voice feature, personal or laptop computer running voice over network or VoIP, etc.).

The operation of the embodiment of FIGS. 6-7 is similar except that the device is hardwired into a handset line. Specifically, handset 138 plugs into casing 100′ by means of cord 133. The connection to the telephone base 132 is completed through casing 100′ by means of line 131. In this embodiment, the previously mentioned coupler 24 (FIG. 1) can simply mix the audio signals or can isolate handset 138 from telephone 132. Isolating handset 138 from telephone 132 is especially useful where one wishes to simulate call waiting by presenting to the remote party a temporarily silent or dead line (intervening quiet interval).

It will be appreciated that in some instances handset 138 will be directly connected to telephone 132 by means of line 133. In this situation, the speaker 20 in casing 100′ can then be placed against and thereby acoustically coupled to the microphone of handset 138 in order to operate in a manner similar to that discussed in connection with the device of FIG. 3.

The operation of the embodiments of FIGS. 9 and 10 are similar except that the device is hardwired into a telephone line. In this case, the previously mentioned coupler 24 (FIG. 1) can simply mix the audio signals or can isolate telephone 28 from telephone line 26. In some instances the device can also cancel intentional background, or comfort noise. Also, isolating telephone 28 from line 26 is especially useful where one wishes to simulate call waiting by presenting to the remote party a temporarily silent or dead line (intervening quiet interval). Moreover, in some embodiments the device may also simulate the aforementioned dead space interspersed with simulated or real voice, or simulated or real background noise, to enhance the likelihood of misperception.

It will be appreciated that the device of FIG. 9 should be connected to a telephone but need not be connected to a telephone. If not connected to a telephone the device can be used party line fashion to interject the simulation signals into the call. It will be appreciated that the device of FIG. 10 operates in a similar fashion.

It will be appreciated that equipment as described in FIGS. 5 and 10 can also work seamlessly with communications over the internet or cellphone networks, the modular jack being replaced with a suitable connector such as an IEEE 802.3 (Ethernet) RJ45 connector or other suitable connector including for example, a software interface. Moreover this system can be arranged to interject the signal into a wireless air interface, using a suitable transmitter in place of the audible or software transducer 20 of FIG. 1. Information concerning this suitable transmitter can be determined from the appropriate specifications (Code Division Multiple Access (CDMA), CDMA2000, Evolution Data Only (EV-DO), Evolution Data Voice (EV-DV), Global System for Mobile (GSM), Enhanced Data for Global Evolution (EDGE), IEEE 802.11 (WIFI), Wide band Code Division Multiple Access (WCDMA), Universal Mobile Telephone System (UMTS), or 802.16 (WIMAX)).

It will be appreciated that the devices of FIGS. 5, 6 and 10 may also be supplemented with calling line identification to automatically interject the appropriate signal once initially identified as unwanted, or undesired. This may be implemented in a self contained fashion, whereby the microcomputer detects the calling line identification by sampling the telephone line, and automatically executes the appropriately predetermined signal sequence.

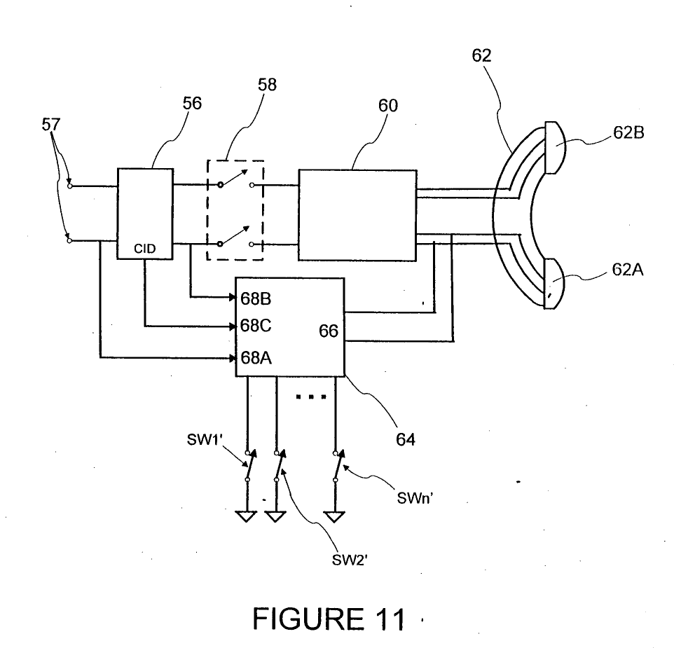

Referring now to FIG. 11, a ringer circuit 56 is connected to telephone. lines 57. Circuit 56 connects through off-hook switch 58 to a main telephone circuit 60, which is shown connected to a telephone handset 62 having a microphone 62A and earpiece 62B. Components 56, 57, 58, 60 and 62 are conventional components of a conventional telephone set.

Generator 64 is essentially the same circuit shown in FIG. 1 except for the elimination of the transducer, the amplifier, and coupler (i.e., elements 18, 20, and 24 of FIG. 1). The output 66 of generator 64 is shown connected in parallel to the microphone 62A of telephone handset 62 to mix the output of the microphone 62A and output 66 of generator 64. Inputs 68A and 68B of generator 64 are connected across ringer circuit 56 to detect a ringing condition and an off hook condition for reasons to be described presently.

The previously mentioned pushbuttons of FIG. 6 are shown herein in FIG. 11 as pushbuttons SW1′, SW2′, . . . and SWn′ all connected between generator 64 and ground. All the equipment of FIG. 11 may be part of a unitary telephone set so that generator 64 may be considered a built-in accessory. Also, while the foregoing suggests a telephone connected to land based lines, generator 64 can be built-in as an accessory to either a cellular telephone, a telephone with built-in answering machine, portable telephone, a PDA used for telephone purposes, a smart phone, a cordless phone, a handheld computer, etc.

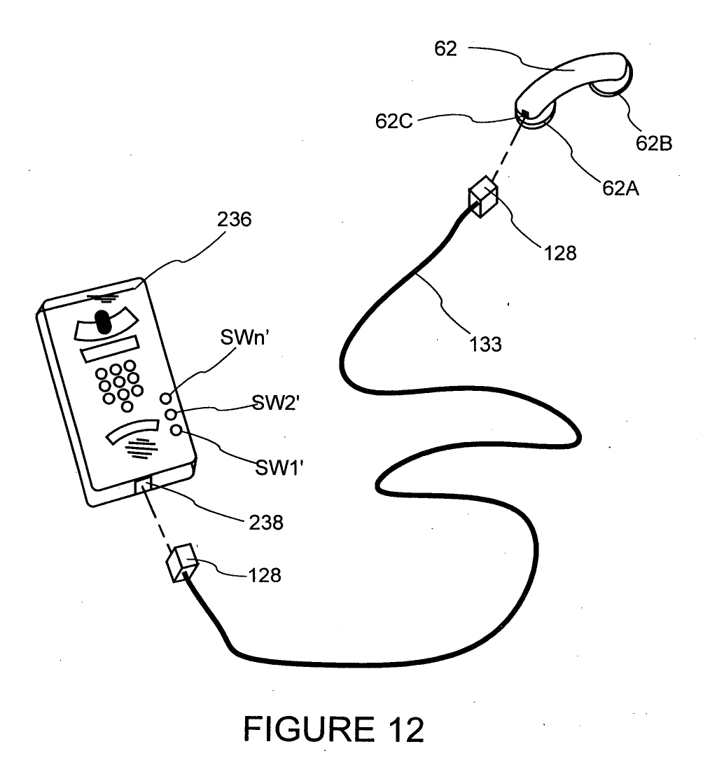

In FIG. 12, previously mentioned handset 62 is shown connected through handset cord 133 to a telephone 236, which contains the circuitry previously illustrated in FIG. 11 (i.e., containing elements 56, 58, 60, and 64).

In particular, the plugs 128 on opposite ends of cord 133 connect to modular jack 62C of handset 62 and modular jack 238 of telephone 236. The handset 62 can be placed on a cradle of telephone 236 in the usual fashion. Previously mentioned switches SW1′, SW2′, and SWn′ are shown accessible on the face of telephone 236.

In operation, generator 64 of FIG. 11 can be used to produce an output after the telephone is answered, that is, after switch 58 is off-hook (closed).

As before, the user can operate any one of the switches SW1′ through SWn′ to produce the simulation signals previously described. These simulation signals are coupled through the microphone circuit of microphone 62A and sent to the remote party along telephone lines 57.

In some embodiments some of the switches SW1′ through SWn′ operate as state switches to change the mode of operation of generator 64. For example, one of the switches can place generator 64 in a facsimile-simulation mode. In that mode inputs 68A and 68B sense when the phone goes off hook and within a few seconds thereafter generator 64 generates at output 66 a signal simulating a facsimile sound. This signal is coupled into- the microphone circuit of microphone 62A to be conveyed through the main circuit 60, switch 58, and ringer circuit 56 to telephone lines 57. Alternatively, after taking the telephone off hook the user can press an appropriate one of the switches SW1′ through SWn′ to initiate the facsimile simulation.

In some embodiments ringer circuit 56 may have a caller ID recognition feature. In such cases the decoded caller ID signal (CID) can be transmitted from output CID of ringer circuit 56 to input 68C of generator 64. The microcomputer in generator 64 may have a code recognition program that recognizes certain disfavored Caller ID's so that generator 64 automatically produces a facsimile signal, or any one of the other signals in the repertoire of generator 64. In fact, the simulation signal can be tailored for each one of the disfavored Caller ID's.

The system can be arranged to delay production of the simulation signal until the telephone goes off hook when either the user lifts the handset off the cradle (or presses an “off-hook”, “send” or “talk” button), or when the telephone automatically answers an incoming call.

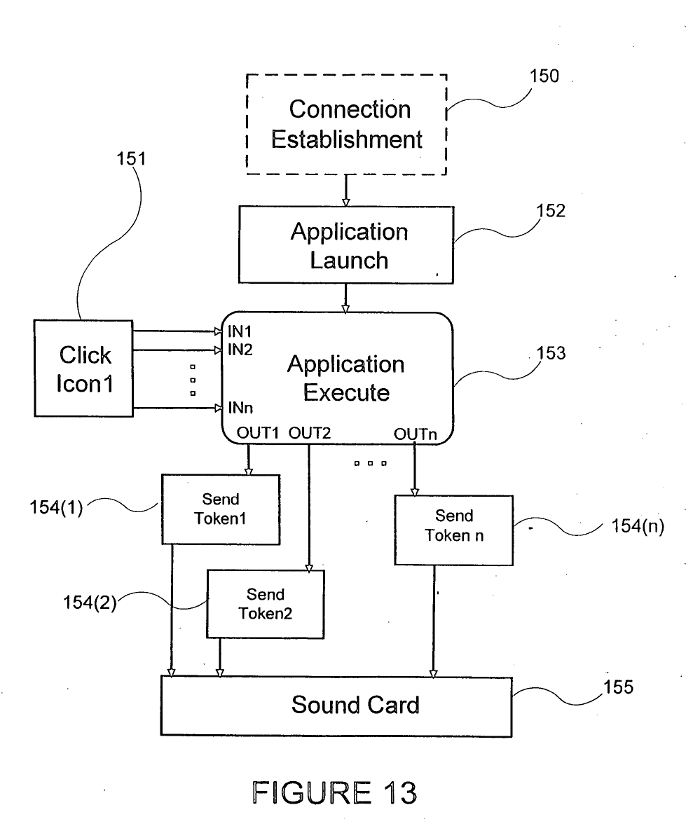

Referring to FIG. 13, the illustrated system is adapted to run in a computer, specifically a personal computer (or a dedicated appliance such as an IP phone, a smartphone, or other telephonic device or apparatus) that is programmed to send voice over a network, e.g. voice over Internet protocol (VoIP). Connections may be made using the Session Initiation Protocol (SIP) with the H323 communications standards over the Open System Interconnection (OSI) routing protocol. This Figure illustrates software cooperating with a sound card 155 installed in a personal computer. Software module 150 employs conventional techniques (e.g., Skype™ software) to establish a VoIP connection using the computer's interface (e.g., monitor, mouse, keyboard, sound card, and microphone). In conventional way a user will send and receive audio through sound card 155, which in turn is conveyed by connection module 150 over the Internet or other network connection to a remote party. This connection through the Internet or other network is another example of what is herein referred to as a telephonic link.

An application designed to implement the previously described simulation features can be launched in step 152 either automatically or in response to manual or voice commands from the user. Step 153 is an application constituting a software implementation- of the generator FIG. 1. At step 153 the application awaits further input from the user. In particular, the application displays in step 151 a number of icons (on the desktop or elsewhere) indicating various simulations the user can initiate. These icons correspond to the pushbuttons previously described (e.g., pushbuttons SW1-SWn of FIG. 1). So for example, a user can click on a first icon to provide a command signal at input IN1 to the main application in step 153. Thus, the mouse/icon interface will be deemed a manual control with a manually operable interface. In response to this action, the application executes step 154(1) in order to send a corresponding token to sound card 155.

The token thus sent to the sound card 155 instructs it to execute the appropriate routine thereby generating the sound sequence previously described as associated with pushbutton SWI of FIG. 1. It will be understood that clicking on various icons will send signals to inputs IN1 through INn to produce various responses much like that previously described in connection with the pushbuttons SW1-SWn.

In some embodiments the token sent to the sound card 155 will be a command to fetch a sound file already stored on card 155. In other embodiments the token will itself be a sound file (e.g. a wav file) or a sequence of sound files.

In any event, sound card 155 will electronically send a digital representation of an appropriate sound to the connection module 150 in order to send a simulation signal over the Internet or other network. Accordingly, the party at the remote end will, as before, perceive a particular telephonic condition. Since the established connection will be VoIP or other type of network connection, different simulations may be desired. For example, the system may stimulate sounds that occur when a poor connection exists. Alternatively, the system may send independent packets that indicate the existence of a third party wishing to establish a party call or engage in instant messaging or text messaging. In some cases the system may send a text message to the remote party simulating some type of message that appears to be generated by the VoIP software (e.g., a text message stating “insufficient memory”, “third party asking to interrupt call”, “another user requests to join”, “priority override”, etc.).

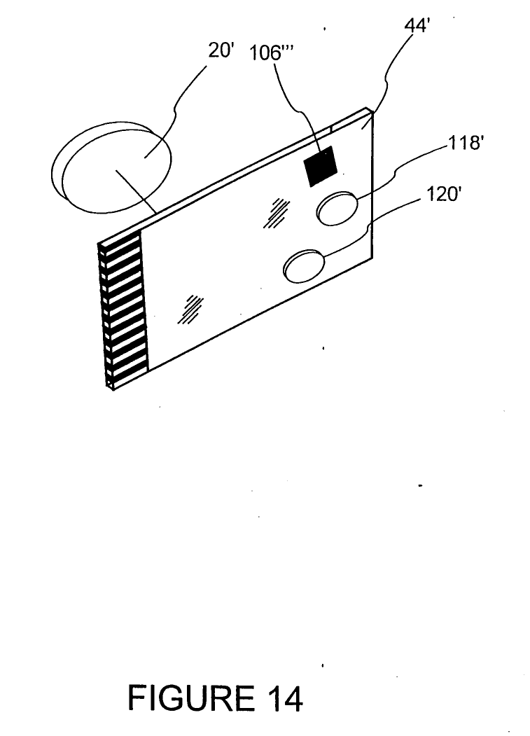

Referring to FIG. 14, components corresponding to those previously shown in FIG. 5 have the same reference numerals but marked with a prime (′). Board 44′ is designed to plug into a personal computer. Integrated circuit 106′″ is similar to the integrated circuit 106′ of FIG. 5 but is designed to cooperate with the balance of circuitry on printed circuit board 44′. The balance of circuitry on board 44′ is that normally found on a sound card. Specifically, board 44′ will have analog to digital as well as digital to analog converters together with an appropriate codec to process the audio signals and digital data. In some embodiments, however, the sound card function will be separated from the simulation processes and each will have its own dedicated card.

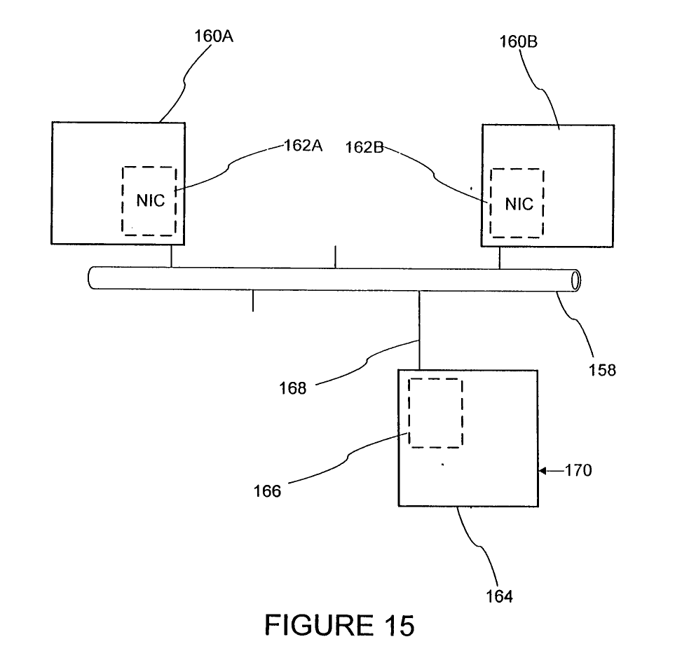

Referring to FIG. 15, a voice over network system is shown operating over network 158, which may be the Internet, a wide area network (WAN), an ATM network, frame relay, advanced intelligent network (AIN), etc. Here, a remote party is using a remote telephonic apparatus 160A while a local party is using a local telephonic apparatus 160B. Devices 160A and 160B may be personal computers, or dedicated equipment such as an IP phone, PDA or smartphone. (Operating in this fashion, such devices are herein referred to as telephonic devices or telephonic apparatus.) Each of the devices 160A and 160B connect to network 158 by means of network interface cards (NIC) 162A and 162B, respectively, operating under the Ethernet standard IEEE 802.3, or other devices that operate like a network interface card. In this embodiment devices 162A and 162B may have their own MAC addresses that operate at a lower level below the IP address and any other higher layer protocols implemented by the software in devices 160A and 160B. A connection can be established by software in devices 160A and 160B in the manner previously described for VoIP. Connections may be made using the Open System Interconnection (OSI) routing protocol.

In this embodiment network communication equipment 164 also has an interface device 166 that connects through line 168 to network 158. That interface device 166 is similar to the previously mentioned devices 162A and 162B, but does not have a fixed MAC address and can instead adopt any MAC address. In some embodiments device 164 can be built into device 160B. Similarly, device 160A can have its own built-in or separate device, similar to device 164.

In operation, the user operating device 160B may wish to end a call with the party at device 160A. Accordingly, the user may send an appropriate command either manually or by other software means along input 170. Device 164 is programmed to respond and cause interface device 166 to generate a number of packets that are inserted along line 168 onto network 158. The software may be the software previously described in connection with FIG. 13 (application 153) but adapted to operate appropriately in the present environment.

The packets generated by this software may produce a sound at device 160A simulating the sounds that occur when the connection becomes unusable or the other party goes off line. In some cases this externally generated sound can simulate an echo suggesting a poor and perhaps unusable connection. Also contemplated is simulation of an alarm that sounds to indicating a low or nearly drained battery condition. In instances where an ultimately audible signal is to be sent, the system may generate an audio signal that is coupled into the circuit for the microphone used by the caller using device 160B for transmission to the party using device 160A. In some instances, the packets from device 164 may send a text message simulating an error signal that could have been generated by the VoIP software on device 160B (e.g., “third party seeks to join/interrupt”, “out of memory”, “system warning”, etc.).

It is significant to notice that the interface device 166 can adopt the MAC address of device 162B and can therefore masquerade as that device. Accordingly, device 160A perceives a single interface device and is not aware of the existence of simulation device 164. It will be appreciated that in some embodiments the connections to the network 158 can be made wirelessly based on the IEEE 802.11 standard or otherwise. In some cases, the wireless connection can be made using cellphone technology.

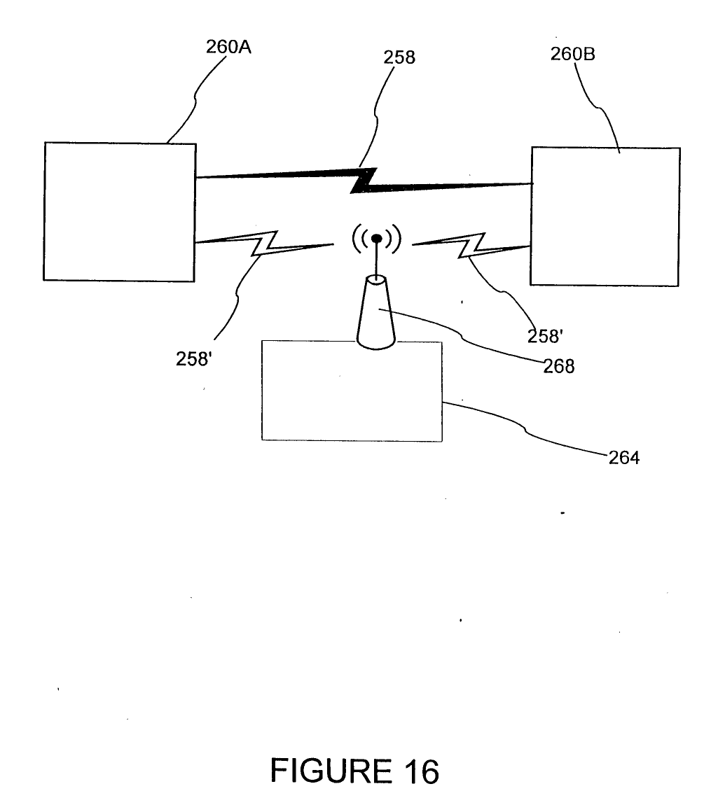

Referring to FIG. 16, components corresponding to those previously illustrated in FIG. 15 have the same reference numerals but increased by 100. In this embodiment connections can be made wirelessly along radio link 258 between devices 260A and 260B (corresponding to devices 160A and 160B of FIG. 15) in order to establish a voice link.

Transceiver 264 performs functions previously described in connection with device 164 FIG. 15 and service multiple devices by connecting via radio links 258′ to devices 260A and 260B. Transceiver 264 senses connection parameters via its receive chain. Using these parameters, the transceiver 264 can use its internal generator to inject signals with appropriate parameters via its transmit chain. Transceiver 264 can be designed with a predetermined expectation of signal conditions.

In manner similar to that previously described in connection with FIG. 15, the internal generator of transceiver 264 can be actuated to inject simulation signals at the required base-band sequence and radio frequency to create the perception that the signals from transceiver 264 are actually part of the call connection along radio link 258.

Transceiver 264 contains a generator as shown in FIG. 1. Transceiver 264 senses at least one of the links 258′ and appropriately configures one or more of its transmit parameters (frequency, sequence, frequency hop sequence, time slot, code sequence, power levels, etc.).

It is anticipated that any of the above communications could constitute a communication with two or more parties or entities.

Obviously, many modifications and variations of the present invention are possible in light of the above teachings. It is therefore to be understood that within the scope of the appended claims, the invention may be practiced otherwise than as specifically described.

1. A device for simulating a telephonic condition, comprising:
a generator operable to produce a simulation signal signifying at least one condition associated with a telephone, said generator having an output adapted to issue the simulation signal over a telephonic link; and
a manual control coupled to said generator and operable to initiate simulation of said at least one condition with a manually operable interface offering one or more selections, said one or more selections comprising at least one of: (a) a second incoming call, (b) an alarm that sounds when a battery is nearly drained in a telephonic device, (c) an intervening quiet interval, and (d) a facsimile tone.

2. A device according to claim 1 wherein said generator is operable to produce the simulation signal to signify at different times said second incoming call, and said facsimile tone.

3. A device according to claim 1 wherein said generator is operable by said manual control to compose the simulation signal to signify an SIT signal.

4. A device according to claim 1 wherein said generator is handheld.

5. A device according to claim 4 wherein said generator includes a battery terminal adapted to connect to a battery in order to supply power to said generator.

6. A device according to claim 4 comprising:
a wallet-sized casing containing said generator.

7. A device according to claim 4 comprising:
a casing having a credit card sized outline, said casing containing said generator.

8. A device according to claim 4 comprising:
a casing containing said generator and having an eyelet for attachment to another object.

9. A device according to claim 1 comprising:
a speaker connected to said output and adapted to acoustically couple into a telephone.

10. A device according to claim 1 comprising:
a memory for digitally storing data corresponding to said simulation signal, said generator being operable to read said data and compose the simulation signal based upon said data.

11. A device according to claim 1 comprising:
a telephone having a microphone subsystem, the output of said generator being coupled to said microphone subsystem.

12. A device according to claim 11 wherein said telephone is cellular.

13. A device according to claim 1 comprising:
a casing containing said generator and having a connector assembly for connecting to the telephone link, said link being a telephone line, said generator being operable to transmit said simulation signal on said telephone line.

14. A device according to claim 13 wherein said connector assembly is adapted to connect between the telephone line and a telephone.

15. A device according to claim 1 comprising:
a circuit card adapted to be mounted in a computer, said generator being incorporated on said card.

16. A device according to claim 15 wherein said circuit card comprises a sound card adapted to connect to a speaker and microphone, said computer being adapted to couple to said telephonic link, said link being a network.

17. A device according to claim 16 wherein said network is the Internet.

18. A device according to claim 1 comprising:
network communication equipment adapted to connect to said telephonic link, said link being a network, said generator being incorporated in said equipment.

19. A device according to claim 18 comprising:
telephonic apparatus adapted to connect to said network and establish a voice over network connection, said network communication equipment operable to issue the simulation signal on said network while masquerading as said telephonic apparatus.

20. A device according to claim 1 wherein said device has a timer for regulating the repetition of said simulation signal

21. A device according to claim 20 wherein said timer prevents said simulation signal from repeating before expiration of a predetermined period.

22. A device according to claim 20 wherein said timer causes the simulation signal to repeat with a predetermined period.

23. A device according to claim 1 comprising:
a caller identification system for decoding identification signals on the telephone link identifying a caller, said generator automatically producing said simulation signal in response to predetermined code in the identification signal.

24. A method for simulating a telephonic condition, comprising the steps of:
generating a simulation signal signifying at least one condition associated with a telephone by offering one or more manual selections, said one or more selections comprising at least one of: (a) a second incoming call, (b) an alarm that sounds when a battery is nearly drained in a telephonic device, (c) an intervening quiet interval, and (d) a facsimile tone; and
issuing the simulation signal over a telephonic link

25. A method according to claim 24 wherein the step of offering one or more manual selections is performed by offering either said second incoming call or said facsimile tone.

26. A method according to claim 24 wherein the step of offering one or more manual selections is performed by offering either said second incoming call or an SIT signal.

27. A method according to claim 24 wherein the step of generating is performed with a generator that is held by hand when operating.

28. A method according to claim 27 wherein said generator has a speaker that is held by hand against a telephone's microphone.

29. A method according to claim 27 comprising the step of:
storing the generator in a wallet.

30. A method according to claim 27 comprising the step of:
holding the generator on a key ring.

31. A method according to claim 24 employing a speaker connected to a generator and comprising the step of:
acoustically coupling the speaker into a telephone by holding the speaker against a microphone of a telephone.

32. A method according to claim 24 employing a telephone having a microphone subsystem, the method comprising the step of:
coupling the simulation signal into the microphone subsystem

33. A method according to claim 24 comprising the step of:
coupling the simulation signal to a telephone line in order to transmit said simulation signal on said telephone line.

34. A method according to claim 24 wherein said method comprises the step of:
regulating the repetition of the simulation signal.

35. A method according to claim 34 wherein the step of regulating the repetition of the simulation signal is performed by preventing the simulation signal from repeating before expiration of a predetermined period.

36. A method according to claim 34 wherein the step of regulating the repetition of the simulation signal is performed by causing the simulation signal to repeat with a predetermined period.

37. A method according to claim 24 comprising:
automatically producing the simulation signal in response to predetermined code in an identification signal from a caller identification system.

38. A method according to claim 24 employing telephonic apparatus and comprising the step of:
establishing a voice over network connection with said telephonic apparatus, the step of issuing the simulation signal being performed by issuing the simulation signal over the network.

39. A method according to claim 38 employing network communication equipment, and comprising the step of:
making the network communication equipment issue the simulation signal while masquerading as said telephonic apparatus.

40. A device for simulating a telephonic condition, comprising:
a handheld generator for producing a simulation signal simulating an audible condition produced on a telephone for signifying a second incoming call, said generator having an output, said generator including a battery terminal adapted to connect to a battery in order to supply power to said generator;
a memory for digitally storing data corresponding to said simulation signal, said generator being operable to read said data and compose the simulation signal based upon said data;
a manual control coupled to said generator for operating it;
a speaker connected to said output of the generator and adapted to acoustically couple into a telephone; and
a timer for regulating the repetition of said simulation signal by (a) preventing the simulation signal from repeating before expiration of a predetermined period, and (b) selectively causing the simulation signal to repeat with a predetermined period.
